(19) United States
(12) Patent Application Publication
(10) Pub. No.: US 2006/0033431 A1
(43) Pub. Date: Feb. 16, 2006

(54) Diode lens

(76) Inventor: Joseph Hsieh, Chang Hua (TW)

Correspondence Address: J.C. Patents, Suite 250, 4 Venture, Irvine, CA, 92618, US

(21) Appl. No.: 10/919,834

(22) Filed: Aug. 16, 2004

(51) Int. Cl. H01J 1/62; H01J 63/04

(52) U.S. Cl. 313/512

(57) ABSTRACT

A colored or clear transparent diode lens to be covered around an LED includes a cover body and plural clamping walls formed to extend down from the over body. The cover body is formed with an accommodating cavity with a downward opening to be stuck with the upper side of the sealed body of the LED. The clamping ribs extend from the outer side of the groove opening and their inner sides are flush with the outer side the LED. Each clamping walls has the lowermost end formed with a projecting-inward edge to be stuck on the lower side of the LED. The clamping walls and the lower side of the LED and a printed circuit board are combined together with dissolved gum, able to be stably combined with an LED for emitting different-colored warning lights, and having functions of water prevention and heat dissipation.

### BACKGROUND OF THE INVENTION

1. Field of the Invention

This invention relates to a diode lens, particularly to one that is a colored or a clear transparent body able to be stably covered around an LED to emit different-colored lights in accordance with the necessity of different functions of lights, such as brake lights, indicator lights, stop lights, reverse lights and license plate lights, having functions of water prevention, heat dissipation and protection.

A conventional lamp is to have plural light emitting diodes orderly assembled on a printed circuit board and then the lamp is installed on an opaque base and sealed up by a lamp shell with colored lens or clear lens. The conventional lamp is fixed in its shape and can only emit a single-colored warning light, having no function of emitting different-colored lights for warning. In addition, if the lampshell of the conventional lamp is broken, the lamp will be unable to emit a colored warning light and the LED will be covered with dust to affect its illumination.

### SUMMARY OF THE INVENTION

The objective of the invention is to offer diode lenses having different colors and forms, able to be stably combined with light emitting diodes to emit various warning lights according to different functions needed.

The diode lens in the present invention includes a cover body and plural (preferably four clamping walls. The cover body has its interior formed with a cylindrical accommodating cavity with a downward opening, and the clamping walls extend down from the opening to define a square space between them, respectively having the lowermost end of the inner side formed with a projecting-inward edge.

The cover body has its accommodating groove covered around a square LED and its groove opening closely stuck on the upper side of the sealed body of the LED. The inner sides of the clamping walls are flush with the outer side of the sealed body of the LED, and the projecting-inward edges of the clamping walls are stuck on the lower side of the sealed body of the LED, letting the diode lens stably covered around the LED. Then, the clamping walls and the lower portion of the sealed body of the LED as well as a printed circuit board are together coated with dissolved gum so as to stabilize their combination and enhance the functions of water prevention and heat dissipation. By so designing, different-colored diode lenses can be respectively and quickly combined with the LED according to the different functions needed, able to be assembled stably and having functions of water prevention, heat dissipation and protection.

The cover body can also be provided with a plurality of supporting members extending from the clamping walls. The supporting members respectively have the lowermost end formed with a projecting-outward edge to be engaged and stuck in the engage hole of the printed circuit board.

### BRIEF DESCRIPTION OF DRAWINGS

This invention will be better understood by referring to the accompanying drawings, wherein:

FIG. 1 is a cross-sectional view of a first preferred embodiment of a diode lens in the present invention:

FIG. 2 is a cross-sectional view of the first preferred embodiment of the diode lens combined with a LED in the present invention:

FIG. 3 is a perspective view of the first preferred embodiment of the diode lens combined with the LED in the present invention:

FIG. 4 is a cross-sectional view of plural diode lenses of the first embodiment combined with a lampshade and a base in the present invention:

FIG. 5 is a perspective view of a second preferred embodiment of a diode lens in the present invention:

FIG. 6 is a cross-sectional view of the second preferred embodiment of the diode lens combined with both the tetragonal sealed base of a LED and a printed circuit board in the present invention: and

FIG. 7 is another cross-sectional view of the second preferred embodiment of the diode lens combined with the shell-shaped sealed base of a LED and the printed circuit board in the present invention.

### DETAILED DESCRIPTION OF THE PREFERRED EMBODIMENT

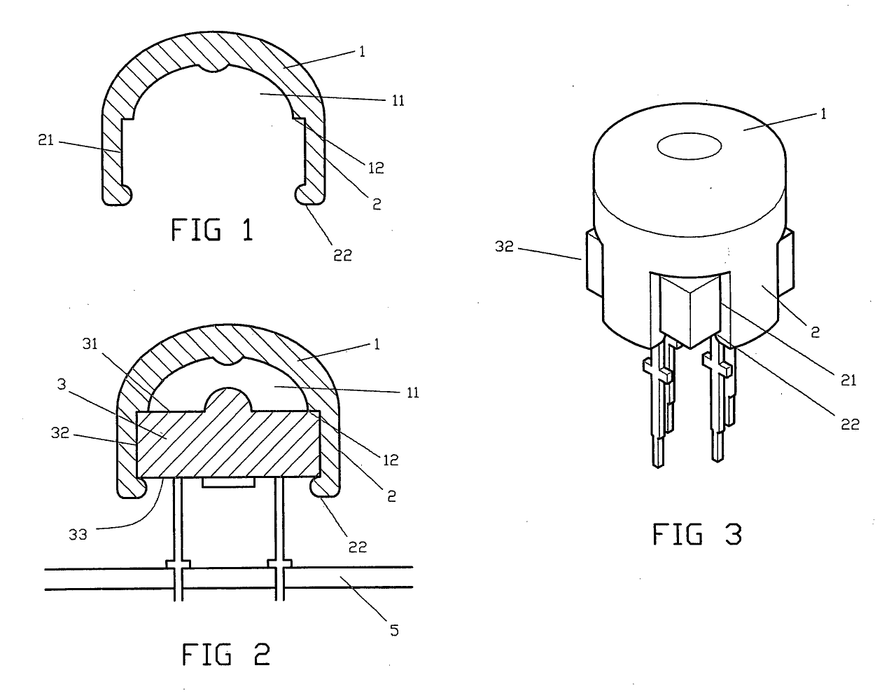

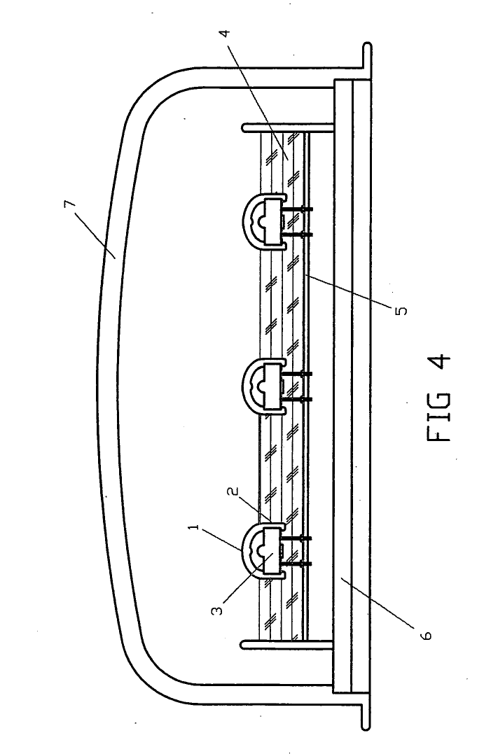

A first preferred embodiment of a diode lens in the present invention, as shown in FIGS. 1 to 4, is a colored or a clear transparent body formed with a cover body 1 with a plurality of clamping walls 2.

The cover body 1 has its interior formed with a cylindrical accommodating cavity 11 with a downward opening 12 to be stuck with the upper side of the sealed base 3 of a LED. The cover body 1 could be of any shape for producing different refracted lights.

The clamping walls 2 define a square space among them and extend down from the opening 12 of the accommodating cavity 11. The inner sides of the clamping walls 2 are flush with the outer side of the sealed body 3 of the LED, and each clamping wall 2 has the lowermost end formed with a projecting-inward edge 22 to be stuck on the lower side 33 of the sealed body 3 of the LED. The clamping walls 2 and the lower side of the sealed body of the LED as well as a printed circuit board 5 are combined together with dissolved gum 4, thus making up a diode lens.

The different-colored diode lenses offered in this invention can be respectively and stably covered around the tetragonal sealed bodies of the light emitting diodes orderly fixed on the printed circuit board 5 according to different functions needed. Then, the diode lens and the light emitting diodes and the printed circuit board 5 are together installed on a base 6 and sealed up by a lampshell 7.

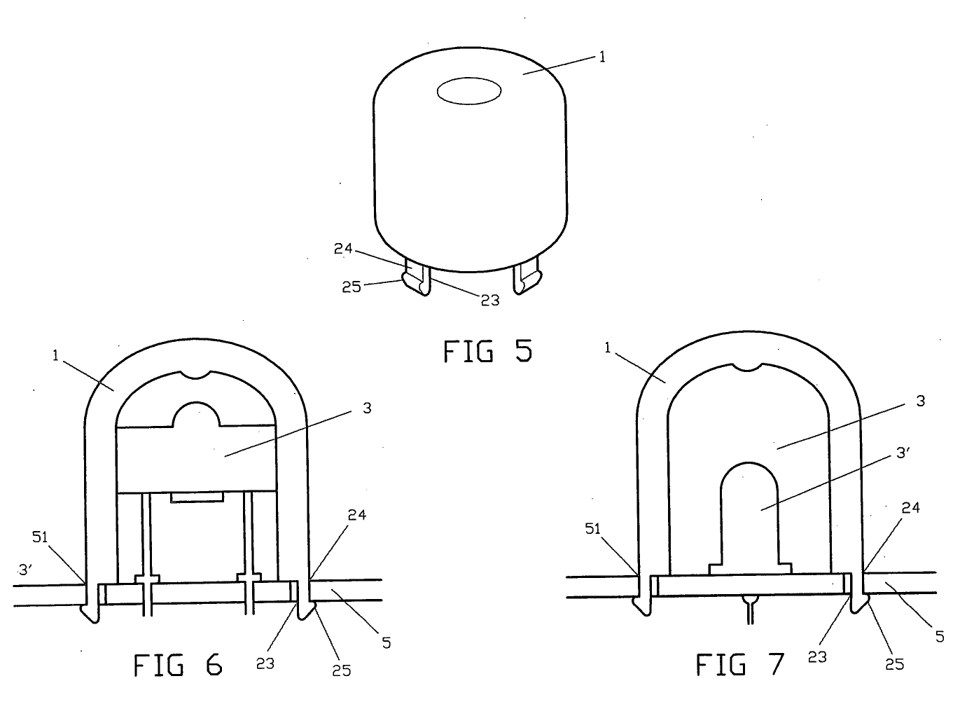

A second preferred embodiment of a diode lens in the present invention, as shown in FIGS. 5 and 6, is to have the cover body 1 provided with a plurality of supporting members 23 extending from the clamping walls 2. Each supporting member 23 has the lowermost end formed with a projecting-outward edge 25 to be engaged and stuck in the engage hole of the printed circuit board 5 to stably cover the cover body 1 around a LED 3 of a tetragonal sealed body or around a LED 3′ with a shell-shaped sealed base, as shown in FIG. 7.

While the preferred embodiments of the invention have been described above, it will be recognized and understood that various modifications may be made therein and the appended claims are intended to cover all such modifications that may fall within the spirit and scope of the invention.

I claim:

1. A colored and transparent diode lens comprising:
A cover body covered around a sealed body of a led, said cover body having its interior formed with a cylindrical accommodating cavity with a downward opening, said downward opening of said accommodating cavity stuck with the upper side of the sealed body of said led: and
A plurality of clamping walls extending from the opening of said cover body, the inner side of each said clamping wall being flush with the outer side of the sealed body of said led, each said clamping wall having the lowermost end formed with a projecting-inward edge, said projecting-inward edge able to be stuck on the lower side of the sealed body of said led.

2. The colored and transparent diode lens as claimed in claim 1, wherein said clamping walls and the lower side of the sealed body of said LED and a printed circuit board are combined together with dissolved gum.

3. The colored and transparent diode lens as claimed in claim 1, wherein a plurality of supporting members extend from the said clamping walls of said cover body, respectively having the lowermost end formed with a projecting-outward edge to be engaged and stuck in the engage hole of said printed circuit board.

4. The colored and transparent diode lens as claimed in claim 1, wherein said cover body could be of any shape for producing different refracting lights.

5. The colored and transparent diode lens as claimed in claim 1, wherein said cover body and said clamping walls are transparent.
